(19) United States
(12) Patent Application Publication
(10) Pub. No.: US 2024/0218708 A1
(43) Pub. Date: Jul. 4, 2024

(54) FOLDABLE LOCK

(71) Applicant: CROPS CO., LTD., TAIPEI CITY (TW)

(72) Inventor: KEIJI TAIGA, TAIPEI CITY (TW)

(21) Appl. No.: 18/148,483

(22) Filed: Dec. 30, 2022

(51) Int. Cl. E05B 71/00

(52) U.S. Cl. CPC E05B 71/00

(57) ABSTRACT

A foldable lock includes a lock bar and a lock body. The lock bar includes a first bar and a second bar. The first bar includes a first end, and the second bar includes a second end. The first end and the second end are respectively and operationally engaged with the lock body when the foldable lock is in a locked status. The first bar and the second bar are pivotably connected to a pivotal portion so that the first bar and the second part are pivotable relative to each other when the foldable lock is in an unlocked status. The lock body includes a storage portion which accommodates at least one of the first bar and the second bar.

### BACKGROUND OF THE INVENTION

### 1. Fields of the Invention

The present invention relates to a lock structure, and more particularly, to a U-shaped foldable lock with foldable portion for convenience of storage and carry.

### 2. Descriptions of Related Art

It is acknowledged that U-shaped locks are widely use to prevent motorcycles or bicycles from being stolen. Although the U-shaped locks are strong enough to prevent theft, they are relatively bulky.

A U-shaped lock known to applicant is disclosed in Japanese Laid-Open Patent No. 7-127322 with the title of folding lock, and which can be folded when not in use for easily carrying. The folding lock includes a U-shaped lock bar and a main part. The lock bar has one end thereof connected to the main part, and the lock bar is pivotable relative to the main part, so as to reduce its overall size by rotating the lock bar and pivoting the main part when not in use.

The present invention intends to provide a foldable lock to eliminate the shortcomings mentioned above.

### SUMMARY OF THE INVENTION

The present invention relates to a foldable lock comprises a lock bar and a lock body. The lock bar includes a first bar that has a first end, and a second bar that has a second end. The first end and the second end are respectively and operationally engaged with the lock body when the foldable lock is in a locked status. The first bar and the second bar are pivotably connected to a pivotal portion so that the first bar and the second part are pivotable relative to each other when the foldable lock is in an unlocked status. The lock body includes a storage portion which accommodates at least one of the first bar and the second bar when the foldable lock is in the unlocked status.

Preferably, the first bar is removably engaged with the lock body.

Preferably, the first bar and the second bar are pivotable relative to each other. The first bar and the second bar are pivoted toward the lock body and accommodated in the storage portion.

Preferably, the storage portion includes a first space and a second space. The first bar is accommodated in the first space of the storage portion, and the second bar is accommodated in the second space of the storage portion.

Preferably, the second end is engaged with a latch located in the first space.

Preferably, a cross sectional area of each of the first bar and the second bar is a rectangular area.

The primary object of the present invention is to provide a foldable lock wherein the second end of the second bar is detached from the lock body when the lock is unlocked, and the second bar is conveniently pivoted toward the first bar. The first and second bars are then pivoted toward the lock body and accommodated in the storage portion. The operation of the foldable lock is easy and convenient.

Another object of the present invention is to provide a foldable lock wherein the foldable lock is compact and easily to be stored and carried when in its folded status.

Yet another object of the present invention is to provide a foldable lock wherein the first bar includes a first straight portion and the second bar includes a second straight portion, the two straight portions make the first and second bars not separate from the storage portion unintentionally.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the foldable lock of the present invention;

FIG. 2 is another perspective view to show the foldable lock of the present invention;

FIG. 3 shows that the second end of the second bar is separated from the lock body;

FIG. 4 shows that the second bar is pivoted toward the first bar;

FIG. 5 shows that the first and second bars are pivoted to be accommodated in the storage portion of the lock body, and

FIG. 6 shows that the foldable lock is secured to a bike frame.

### DETAILED DESCRIPTION OF THE PREFERRED EMBODIMENT

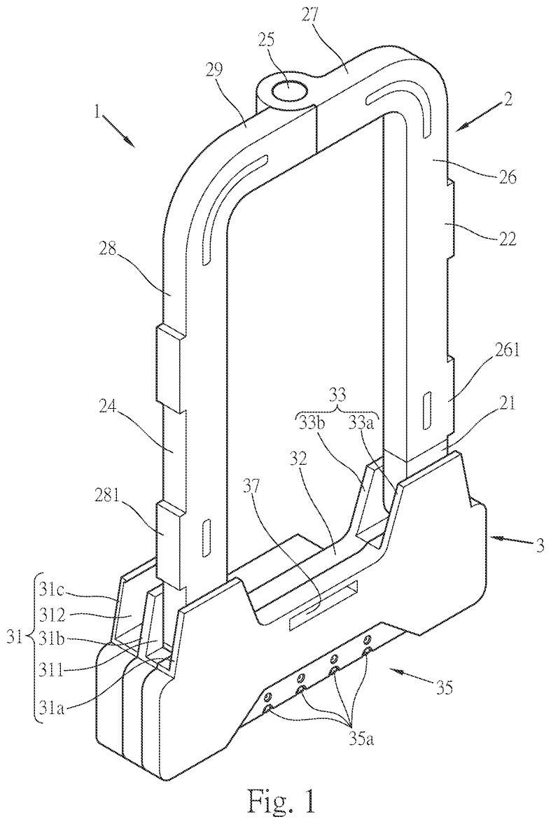

Referring to FIGS. 1 to 5, the foldable lock 1 of the present invention comprises a lock bar 2 and a lock body 3, wherein the lock bar 2 is a U-shaped bar and includes a first bar 22 and a second bar 24. The first bar 22 and the second bar 24 are pivotably connected to a pivotal portion 25 that is located at the middle position of the U-shaped bar. Therefore, the first bar 22 and the second bar 24 are pivotable relative to each other when the foldable lock 1 is in an unlocked status. The first bar 22 includes a first end 21, and the second bar 24 includes a second end 23. The first end 21 and the second end 23 are respectively and operationally engaged with the lock body 3 when the foldable lock 1 is in a locked status.

Specifically, the first end 21 of the first bar 22 is detachable relative to the lock body 3, and the second end 23 of the second bar 24 I pivotably connected to the lock body 3. When the foldable lock 1 is in the locked status, the first end 21 of the first bar 22 is engaged with the lock body 3. When the foldable lock 1 is in the unlocked status, the first end 21 of the first bar 22 is removed from the lock body 3.

The first bar 22 includes a first straight portion 26 which is formed between the first end 21 and a first extension 27. The first extension 27 extends at an angle relative to the first straight portion 26. The second bar 24 includes a second straight portion 28 which is formed between the second end 23 and a second extension 29. The second extension 29 extends at an angle relative to the second straight portion 28. The pivotal portion 25 is located between the first and second extensions 27, 29. A first protrusion 261 extends from the first straight portion 26 and is located close to the first end 21. The first protrusion 261 extends in a direction opposite to that of the first extension 27. A second protrusion 281 extends from the second straight portion 28 and is located close to the second end 23. The second protrusion 281 extends in a direction opposite to that of the second extension 29.

The first bar 22 and the second bar 24 are symmetrical relative to an axis of the pivotal portion 25. The pivotal portion 25 can be any known pivotable structure such as a hinge.

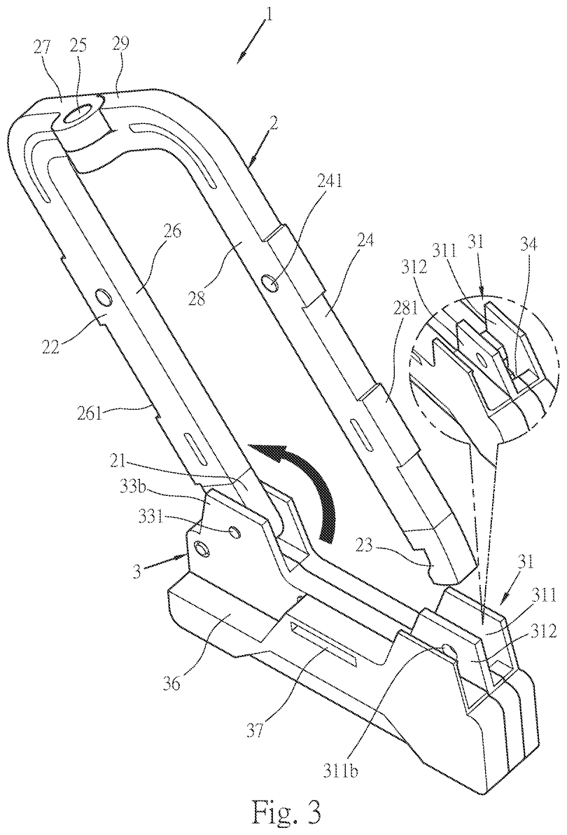

The lock body 3 includes a storage portion 31 and a retaining portion 33 respectively located at two ends of the lock body 3. The storage portion 31 includes a first wall 31a, a second wall 31b and a third wall 31c respectively extending upward from the lock body 3. A first space 311 is formed between the first wall 31a and the second wall 31b. A second space 312 is formed between the second wall 31b and the third wall 31c. A latch 34 is located in the first space 311 as shown in FIG. 3.

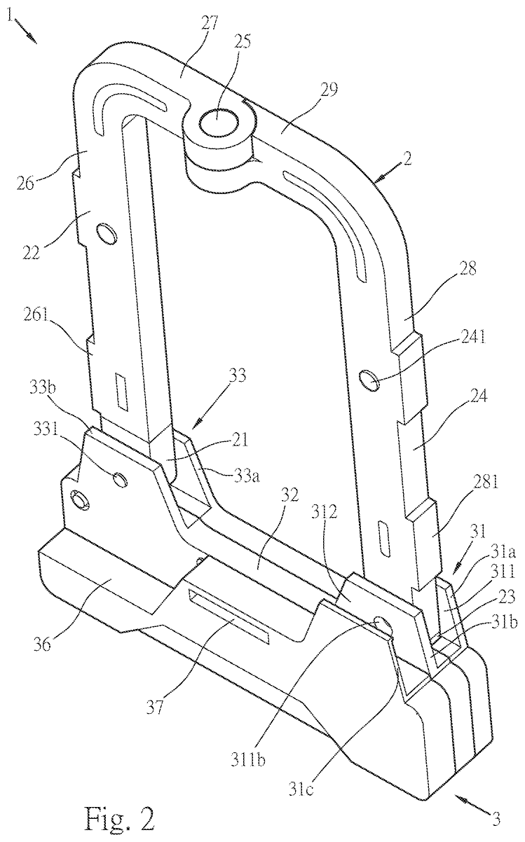

The retaining portion 33 includes two sidewalls 33a, 33b between which a space is formed. The first end 21 is pivotably connected between the two sidewalls 33a, 33b by a pin 331 which can be a rivet for example. When the foldable lock 1 is locked, as shown in FIGS. 1 and 2, the second end 23 is engaged with the latch 34 in the first space 311 of storage portion 31.

The cross sectional area of each of the first bar 22 and the second bar 24 is a rectangular area. The first bar 22 and the second bar 24 each are an elongate bar so that when the first and second bar 22, 24 are overlapped with each other, a less space is needed to store the first and second bars 22, 24.

The lock body 3 further includes an operation portion 35 which controls the latch 34 to be engaged with the second end 23 of the second bar 24. In this embodiment, the operation portion 35 includes four number wheels 35a, and each number wheel 35a includes ten numbers from 0 to 9. A user of the foldable lock 1 can set a combination by the four number wheels 35a to control the second end 23 to be engaged with or separated from the latch 34.

The lock body 3 has a recessed area 36 as shown in FIG. 3, the recessed area 36 allows the second end 23 not to hit the lock body 3 when being folded. A slot 37 is defined through the lock body 3 transversely.

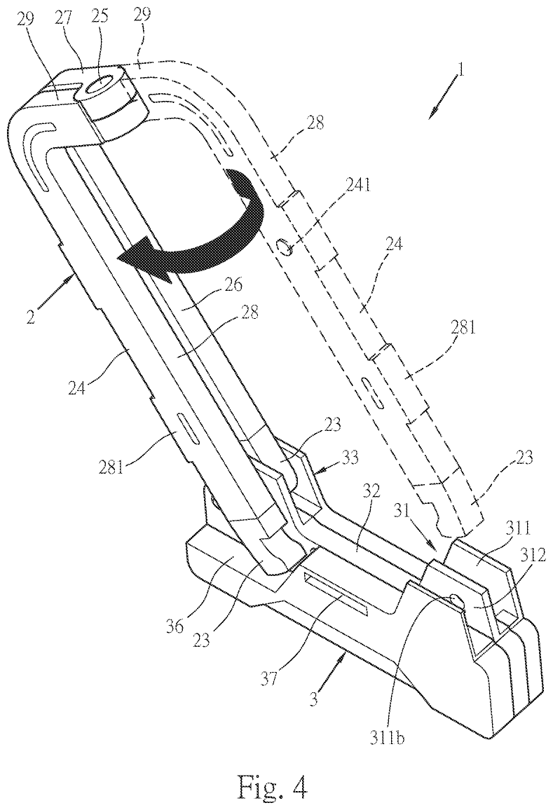

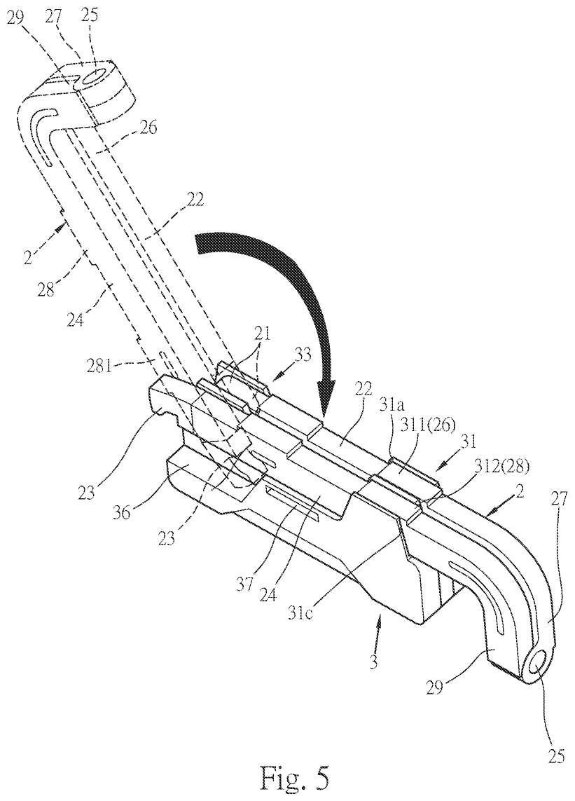

When unlocking the foldable lock 1, as shown in FIGS. 3 to 5, the user operates the number wheels 35a so that the second end 23 is able to be separated from the latch 34, and the first end 21 is pivoted about the pin 331. The second bar 24 is then pivoted about the pivotal portion 25 and overlaps the first bar 22 as shown in FIG. 4. The recessed area 36 accommodates the second end 23 so that the second end 23 does not hit the lock body 3. The overlapped first and second bars 22, 24 are pivoted downward and toward the lock body 3, such that the first bar 22 is engaged with the first space 311, and the second bar 24 is engaged with the second space 312 as shown in FIG. 5. The foldable lock 1 in the folded status is compact and easily carried and stored.

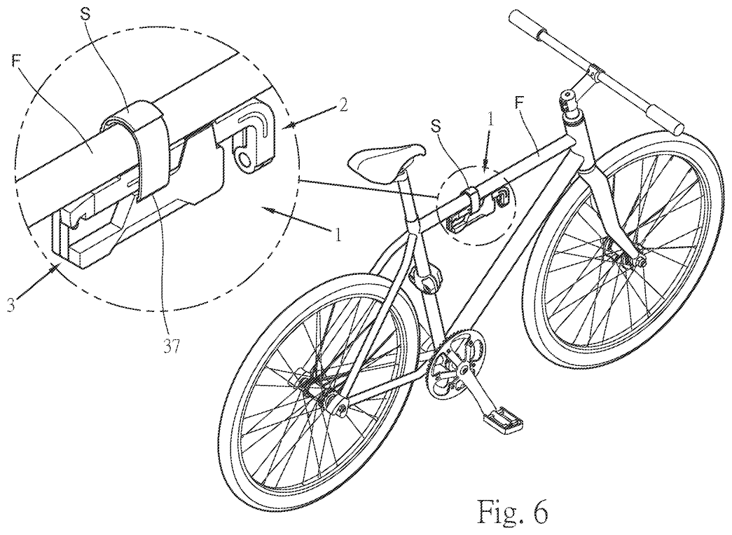

As shown in FIG. 6, a band “S” extends through the slot 37 and ties the foldable lock 1 to the bike frame “F”. As shown in FIG. 5, the height from the lower end of the transverse portion 32 to the top edge of the storage portion 31 is the same as the height from the lower end of the transverse portion 32 to the top edge of the retaining portion 33. The height from the lower end of the transverse portion 32 to the top edge of the first protrusion 261 is the same as the height from the lower end of the transverse portion 32 to the top edge of the second protrusion 281. The first and second extensions 27, 29 protruding from one end of the lock body 3 has similar height as those heights mentioned above. The specific feature makes the foldable lock 1, in the folded status, is easily and stably positioned to the bike frame “F”.

The cross sectional shape of the foldable lock 1 in the folded status is a rectangular shape which is not limited to. The number of the number wheels 35a can be more than four or less than four. The operation portion 35 can also be cooperated with a key to control the foldable lock 1.

The first bar 22 does not need to be attached to the lock body 3. The lock body 3 and the lock bar 2 can be two individual parts. The storage portion 31 is optionally to be engaged with the first bar 22 or the second bar 24. In addition, the storage portion 31 may include only the first and third walls 31a, 31c, and the first and second bars 22, 24 can be engaged between the first and third walls 31a, 31c. Any one of the first and third walls 31a, 31c may have a lip to prevent the first and second bars 22, 24 from disengaging from the storage portion 31 as shown in FIGS. 2 and 3.

As shown in FIG. 4, the second bar 24 has a boss 241 extending from one of two opposite faces thereof. The second wall 31b includes a hole 311b which accommodates the boss 241 when the second bar 24 is engaged with the second space 312 to prevent the second bar 24 from disengaging from the second space 312.

The foldable lock 1 of the present invention is suitable for being used to bikes or motorbikes.

While we have shown and described the embodiment in accordance with the present invention, it should be clear to those skilled in the art that further embodiments may be made without departing from the scope of the present invention.

What is claimed is:

1. A foldable lock comprising:
a lock bar and a lock body, the lock bar including a first bar and a second bar, the first bar including a first end, the second bar including a second end, the first end and the second end respectively and operationally engaged with the lock body when the foldable lock is in a locked status, the first bar and the second bar pivotably connected to a pivotal portion so that the first bar and the second bar are pivotable relative to each other when the foldable lock is in an unlocked status, and
the lock body including a storage portion which accommodates at least one of the first bar and the second bar.

2. The foldable lock as claimed in claim 1, wherein the first bar is removably engaged with the lock body.

3. The foldable lock as claimed in claim 2, wherein the first bar and the second bar are pivotable relative to each other, the first bar and the second bar are pivoted toward the lock body and accommodated in the storage portion.

4. The foldable lock as claimed in claim 3, wherein the storage portion includes a first space and a second space, the first bar is accommodated in the first space of the storage portion, the second bar is accommodated in the second space of the storage portion.

5. The foldable lock as claimed in claim 4, wherein the second end is engaged with a latch located in the first space.

6. The foldable lock as claimed in claim 1, wherein a cross sectional area of each of the first bar and the second bar is a rectangular area.
